(19) United States
(12) Patent Application Publication
(10) Pub. No.: US 2010/0245678 A1
(43) Pub. Date: Sep. 30, 2010

(54) TELEVISION APPARATUS

(75) Inventor: David Richard HILL-JOWETT, Chineham (GB)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY UNITED KINGDOM LIMITED, Weybridge (GB)

(21) Appl. No.: 12/687,396

(22) Filed: Jan. 14, 2010

(30) Foreign Application Priority Data
Mar. 27, 2009 (GB) 0905351.3

(51) Int. Cl. H04N 5/63

(52) U.S. Cl. 348/730; 348/E05.127

(57) ABSTRACT

A television apparatus including a register for storing a plurality of events, each event indicating both a time and an operation to be conducted by the television apparatus at that time, a power supply operable to power the television apparatus selectively in a powered-up state or a standby state and a controller arranged so as, in response to a clock reaching a time stored for one of said events, to control the power supply to switch from the standby state to the powered-up state and to cause the respective operation to be conducted by the television apparatus. The television apparatus is arranged to store information indicating, for at least the stored event having the latest time, whether to switch to the standby state or a shutdown state, the power supply being shut down in the shutdown state. The controller is arranged so as, in response to completion of the respective operation of the stored event having the latest time, to control the power supply to switch from the powered-up state to, according to said information, either the standby state or the shutdown state.

### CROSS-REFERENCE TO RELATED APPLICATIONS

This application is based upon and claims the benefit of priority from British Application No. 0905351.3 filed 27 Mar. 2009, the entire contents of which are incorporated by reference.

### BACKGROUND OF THE INVENTION

1. Field of the Invention

The present invention relates to a television apparatus and also to a method of controlling a television apparatus in particular in relation to controlling functions of shutdown or standby after preset timed events.

2. Description of the Related Art

It is well known to provide a television apparatus, such as a video recorder (VCR) or personal video recorder (PVR) which is set to record television programmes at times in the future. In order to achieve this functionality, the television apparatus remains in a standby state until recording is required. In particular, all circuits except those monitoring the time can be powered down. When the required time is reached, or perhaps a preset time in advance of that required time, the controller of the television apparatus powers up the television apparatus as a whole such that recording can take place. At the end of the recording function, the television apparatus is returned to its standby state.

Similar operations occur for other timed events in recorders or other types of television apparatus, for instance powering up to receive updates to an electronic programme guide (EPG), software/middleware or powering up to start reproduction of a television programme as a wake-up function.

### OBJECTS AND SUMMARY OF THE INVENTION

It has also been recognised in the prior art that leaving devices in a standby state is undesirable in the sense of consuming unnecessary power. The present invention has been devised in consideration of this problem.

According to the present invention, there is provided a method of controlling a television apparatus, the television apparatus being either in a shutdown state or operable in a standby state or a powered-up state. The method includes storing a plurality of events, each event indicating both a time and an operation to be conducted by the television apparatus at that time, upon reaching a time stored for one of said events, switching from the standby state to the powered-up state and conducting the respective operation, storing information indicating, for at least the stored event having the latest time, whether to switch to the standby state or the shutdown state, and, upon completing the respective operation of the stored event having the latest time, switching from the powered-up state to either the standby state or the shutdown state according to the stored information.

According to the present invention, there is also provided a television apparatus including a register for storing a plurality of events, each event indicating both a time and an operation to be conducted by the television apparatus at that time, a power supply operable to power the television apparatus selectively in a powered-up state or a standby state, a controller arranged so as, in response to a clock reaching a time stored for one of said events, to control the power supply to switch from the standby state to the powered-up state and to cause the respective operation to be conducted by the television apparatus. The television apparatus is arranged to store information indicating, for at least the stored event having the latest time, whether to switch to the standby state or a shutdown state, the power supply being shut down in the shutdown state. The controller is arranged so as, in response to completion of the respective operation of the stored event having the latest time, to control the power supply to switch from the powered-up state to, according to said information, either the standby state or the shutdown state.

In this way, after the final timed event set for the television apparatus has occurred, the television apparatus can be driven to a shutdown state whereby no power is consumed by it. Of course, this means that the controller (and perhaps a remote control unit) will not be able to restart or power up the television apparatus. However, because the shutdown operation only occurs after the last event, this will be acceptable to a user. It will be a simple matter for the user returning to the television apparatus to activate any main power switch on the television apparatus to reactivate its power supply and return the television apparatus to a powered-up state.

The television apparatus may be arranged to store the information for each respective event. The controller may then be responsive only to the information stored for the stored event having the latest time.

Each time an event occurs and the television apparatus carries out the respective operation, the controller can check the information stored for that respective event to see whether the television apparatus is to switch to the standby state or the shutdown state at the end of the operation. However, only if the event in question is the last event stored for the television apparatus will the controller act on information instructing the television apparatus to be switched to the shutdown state. Of course, in practice, the controller could merely first check to see whether the event is the last event and, only if the event is the last event, then refer to the information stored for that respective event.

Alternatively the television apparatus could include a mode register. The information can then be stored in the mode register as either a standby mode or a shutdown mode. The controller is then preferably arranged so as, upon completion of the respective operation of the stored event having the latest time, to refer to the mode register and to control the power supply to switch to the standby state when the standby mode is stored or to switch to the shutdown state when the shutdown mode is stored.

In this way, a user of the television apparatus need not consider, for each event, whether or not the television apparatus should end by switching to the standby state or the shutdown state. Instead, the user can merely choose in which mode the television apparatus is to be used. In other words, if the user selects the standby mode, the stored information in the mode register is the standby mode and, at the end of the operation of the final event, the television apparatus will merely return to the standby mode. On the other hand, if the user chooses the shutdown mode, the shutdown mode is stored in the mode register and, at the end of the operation of the final event, the television apparatus will switch to the shutdown state.

The present invention is not limited to any particular type of timed event. The operations can include a selection of different types of event, such as recording a received television programme, reproducing a television programme and uploading software/middleware upgrades, including upgrade EPG information.

The present invention may also be embodied in any television apparatus which carries out timed events and which can be switched between a powered-up state, a standby state and a shutdown state. Examples of devices which can embody the present invention include a television receiver, a television programme recording device and a television programme reproducing device.

The present invention can also, of course, be embodied in software, for instance for loading onto an appropriate device such as a computer or television apparatus.

Standby state can be considered to be any state which requires current to be drawn to maintain it that state and in particular to maintain it in a state of readiness to perform an action, for example:
Maintaining a remote control signal receiver active so that it can react to a wireless command to start up
maintaining a “wake on LAN” status which allows a device to be turned on remotely in response to a remote command from a connected wired network or possibly a wireless network
maintaining a status which enables faster start up by keeping some, but not all, components powered up.

Shutdown state can be considered as:

Zero Watts plus any “no load losses” resulting from the device being plugged into mains electricity, such as current drawn by the coils of a transformer. The transformer can be designed to reduce or obviate such no load losses to improve the benefits of the invention.

A “Hibernate” state in which all settings of the previous powered on state are stored in static memory and then reused on start up to enable a faster start up falls within the definition of shutdown state since the maintenance of the hibernate state requires no power to maintain it.

### BRIEF DESCRIPTION OF THE DRAWINGS

FIGS. 1(a) and (b) illustrate examples of a television apparatus embodying the present invention;

FIG. 2 illustrates schematically internal component parts of a television apparatus embodying the present invention; and

FIG. 3 illustrates schematically a process conducted according to the present invention.

### DETAILED DESCRIPTION OF THE PREFERRED EMBODIMENTS

The invention will be more clearly understood from the following description, given by way of example only, with reference to the accompanying drawings.

The present invention can be embodied in any television apparatus configured to operate a timed event, such as recording of a broadcast/streamed television programme consisting of audio and video data, start of reproduction of such a television programme as a wake-up function or uploading of software/middleware upgrades at a known future time.

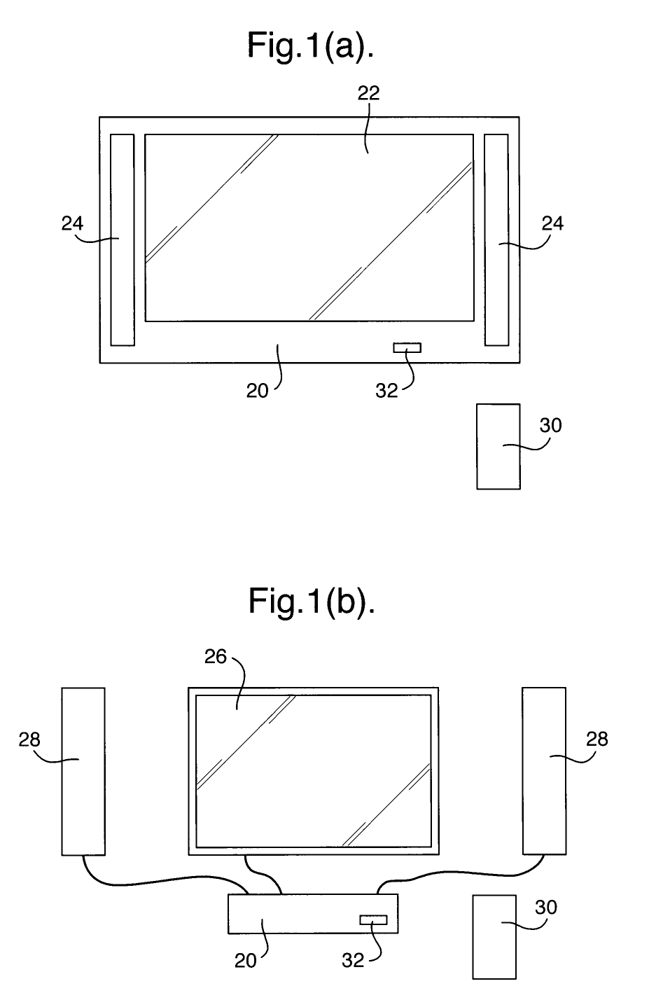

In the arrangement of FIG. 1(a), the television apparatus 20 itself includes a display 22 and pair of loudspeakers 24 acting as an audio transducer. In the example of FIG. 1(b), the television apparatus 20 takes the form of a set-top box which can be connected to a separate display 26 and separate loudspeakers 28 acting as audio transducers.

In both examples, the television apparatus 20 is provided with a user interface 30 in the form of a remote control unit and a remote control signal receiver 32.

In the preferred embodiment, the television apparatus 20 also includes a recording device for recording a received television programme, for instance onto tape, disk or harddrive (HDD).

As is well known, it is possible for a television apparatus to be operated in a standby state. In such a standby state, recording and reproduction of television programmes is not possible and the television apparatus appears to be switched off. Actually, when the television apparatus is in the standby state, at least a main power supply remains active and the remote control signal receiver 32 remains powered up. In this way, when the television apparatus 20 is in the standby state, it can still respond to remote control signals from the remote control unit 30. A user is able to bring the television apparatus 20 into a powered-up state from the standby state by operating the remote control unit 30.

If the television apparatus 20 is to remain unused for an extended period of time, it is undesirable to leave it in the standby state, because the main power supply must remain on and power is consumed unnecessarily by it and the remote control signal receiver 32.

It is known that a user can completely turn off the television apparatus 20 by disconnecting the external power supply or merely by operating a main power switch provided on the television apparatus 20 itself or indeed possibly the remote control unit 30.

Once in the shutdown state, the television apparatus 20 has no power provided to any of its circuits and it is not possible to reactivate or control the television apparatus 20 by means of the remote control unit 30.

When the television apparatus 20 is in the standby state, other operations may periodically be powered. For example, the television device 20 might periodically, for instance once each day, power up television broadcast reception circuits so as to receive ancillary data, such as electronic programme guide (EPG) data for updating any corresponding stored data. This may be useful where the television apparatus 20 has been programmed by the user to record a desired television programme at a future time or indeed to record television programmes according to the taste of the user, for instance as is done with a personal video recorder (PVR).

With the present invention, it is proposed that, at the end of an event for the television apparatus 20, for instance the recording of a particular television programme, the television apparatus 20 can be set automatically to change to a shutdown state, rather than a standby state as would be known from the prior art.

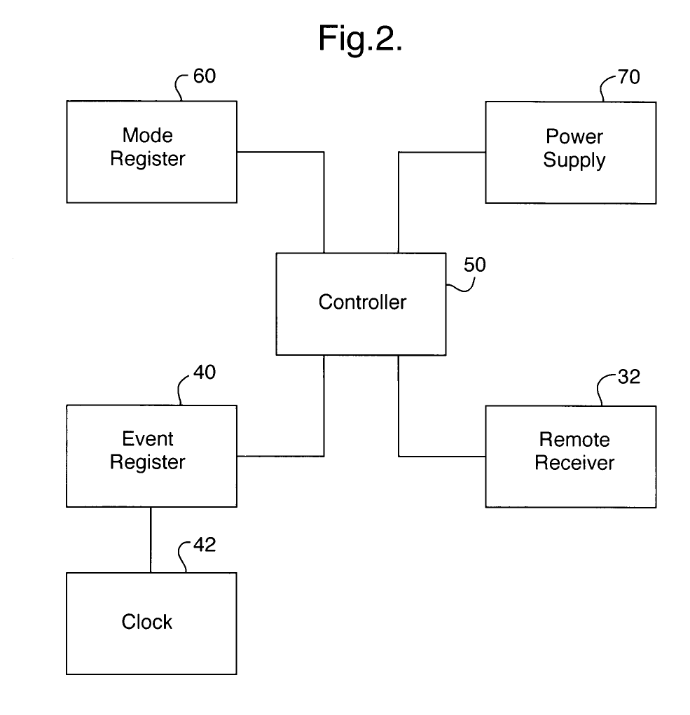

FIG. 2 illustrates schematically relevant component parts of a television apparatus embodying the present invention.

As illustrated, the television apparatus includes an event register 40 provided in conjunction with a clock or timer 42. The event register 40 includes a list of events for the television apparatus, each event indicating a particular operation for the television apparatus at an associated time. A notable example of an event for which the present invention is particularly advantageous is the operation of recording a particular television programme at a preselected time.

When the television apparatus is in the standby state and the clock 42 indicates that the actual time matches the time of an event in the event register 40, a controller 50 of the television apparatus initiates the required operation, for instance recording of the required television programme.

As illustrated, a mode register 60 is also provided. The mode register 60 stores a record, for instance by means of a flag, as to whether a standby mode or a shutdown mode has been selected by a user for the television apparatus.

At the end of carrying out an operation as specified by an event in the event register 40, the controller 50 checks the mode register 60 to determine whether or not the television apparatus has been set to the standby mode or the shutdown mode. If the television apparatus has been set to the standby mode, then the controller 50 controls the television apparatus to return to a standby state. As explained above, in the standby state, it is possible to terminate power to all parts of the television apparatus apart from the remote control signal receiver 32. However, in the preferred embodiment, power is also maintained to the event register 40 and clock 42. In this way, if a remote control device is operated, the remote control signal receiver 32 can cause the television apparatus to return to a powered-up state. Also, if the actual time reaches the time of another event in the event register 40, again, the television apparatus can return to the powered-up state so that the controller 50 can initiate the operation of the event scheduled for that time.

If, when the controller 50 refers to the mode register 60 at the end of a particular operation and the mode register 60 is set to the shutdown mode, then, instead of returning the television apparatus to a standby state, the controller can operate the power supply 70 to turn off power to all parts of the television apparatus and, hence, drive the television apparatus to the shutdown state. As explained above, from this shutdown state, the entire television apparatus is inoperable until the power supply 70 itself is operated to provide power once more to circuits of the television apparatus.

Of course, if the event register 40 still contains a register of future events for the television apparatus, reacting to the shutdown mode in the mode register 60 to shut down the television apparatus may be undesirable. Hence, before the controller 50 operates to drive the television apparatus to the shutdown state, it is configured first to check the event register 40 to determine whether or not any future events are registered. Only if there are no future events registered does the controller 50 react to the shutdown mode in the mode register 60 to shut down the television apparatus. If future events are contained in the register 40, then the controller 50 operates to drive the television apparatus to the standby state despite the shutdown mode being registered in the mode register 60.

It should be appreciated that the event register 40 need not only store a register of individual particular events. It may also store, as events, an indication that a user wishes to record a series of related television programmes such that the event register 40 acquires details of those related programmes as and when the details become available. Similarly, the event register can register the fact that the television apparatus is set to record automatically programmes of one or more particular types. In either case, if the controller 50 determines that such details are stored in the event register 40, it is configured to ignore the shutdown mode stored in the mode register 60 and drive the television apparatus to the standby state rather than to the shutdown state.

In operation, the television apparatus, for instance by way of using the controller 50 and a user interface (for instance using the display 22 or 26), prompts the user to set the television apparatus in either the standby mode or the shutdown mode and registers the selected mode in the mode register 60. Prompting the user in this way can be carried out as an individual or standalone function of the television apparatus. In other words, the user sets the required mode of operation, either the standby mode or shutdown mode, and when the controller 50 determines that the last event in the event register 40 has been completed, shuts down the television apparatus if the shutdown mode is in the mode register 60. In a preferred embodiment, each time a user sets a new event in the event register 40 (for instance using a graphical user interface on for example the display 22 or 26), the television apparatus provides an indication of the current mode registered in the mode register 60 for that event. The option may be given to the user to change the registered mode at that stage. If the user is entering a new event which will not be the last event registered in the event register 40, then, of course, the distribution apparatus will not allow the user to select the shutdown mode for that new event, but shutdown can still occur at the end of the last event. Likewise, if a user registers the requirement for a series link for a series of broadcast programmes, the television apparatus can indicate that the shutdown mode is not available.

Although FIG. 2 illustrates schematically a mode register 60 separate from the event register 40, it is possible for the two registers to be combined. In other words, each event registered in the event register 40 may additionally include information, for instance a flag, indicating whether the standby mode or shutdown mode has been selected for the end of that event. With such an arrangement, the controller 50 will only consider the information given regarding standby mode or shutdown mode for the last event registered in the event register 40 and will always operate to drive the television apparatus to the standby state at the end of events which are not the last event in the event register 40.

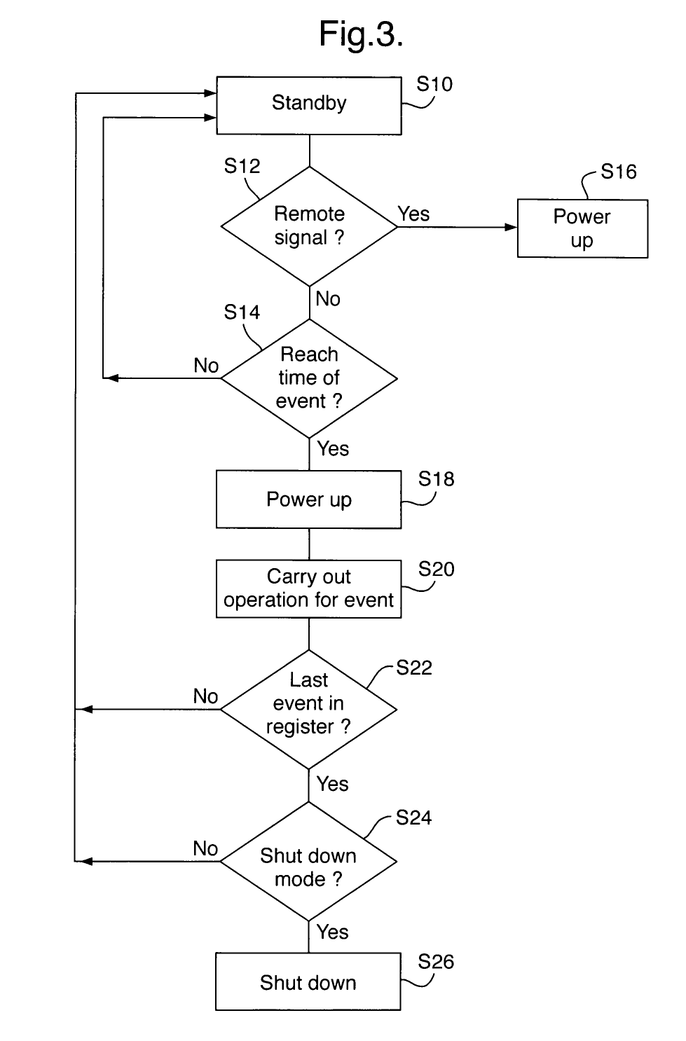

FIG. 3 illustrates schematically operation of a television apparatus embodying the present invention. This process may be carried out by means of a controller, such as controller 50 of FIG. 2 and may be embodied as a computer program for operating a television apparatus.

With the television apparatus starting in a standby state S10, in effect, the process regularly checks to see whether the remote control unit 30 has been operated or the actual time has reached the time of a registered event. This is shown schematically by step S12, which checks whether or not a remote control signal has been received by the remote control signal receiver 32, and by step S14, which checks whether or not the actual time has reached the time of an event in the event register 40. If neither of these conditions are met, then the television apparatus remains in the standby state S10. In a practical embodiment of this process, it is also possible for the remote control signal receiver 32 and event register 40 to be able to issue a signal, such as an interrupt to the controller 50 such that steps S12 and S14 could be replaced by a step where the controller merely awaits an indication from either the remote control signal receiver 32 or the event register 40 that powering up is required.

If a remote control signal is received by the remote control signal receiver 32, then the television apparatus is powered up in step S16 and the controller follows whatever instructions are provided by the user with the remote control unit 30.

If the controller is required to initiate an operation specified in an event registered in the event register 40, then the television apparatus is powered up in step S18 and then the required operation of the respective event is carried out in step S20.

After the operation has been conducted, in step S22, a check is made as to whether the corresponding event in the event register 40 was the last event in the event register 40. If the event was not the last event in the event register 40, then the process can return to the standby state in S10, because, irrespective of the selected mode, it is not possible, to shut down the television apparatus.

If it is determined in step S22 that the operation carried out in step S20 was the last event in the event register, then, in step S24, a check is made as to whether the shutdown mode has been registered in the mode register (or registered in the event register in association with the event for which step S20 was conducted). If the shutdown mode was not registered, then the process can return to the standby state of step S10. However, if the shutdown mode was registered, then the process continues to step S26 to shut down the entire television apparatus.

We claim:

1. A television apparatus including:
a register for storing a plurality of events, each event indicating both a time and an operation to be conducted by the television apparatus at that time;
a power supply operable to power the television apparatus selectively in a powered-up state or a standby state;
a controller arranged so as, in response to a clock reaching a time stored for one of said events, to control the power supply to switch from the standby state to the powered-up state and to cause the respective operation to be conducted by the television apparatus; wherein
the television apparatus is arranged to store information indicating, for at least the stored event having the latest time, whether to switch to the standby state or a shutdown state, the power supply being shut down in the shutdown state; and
the controller is arranged so as, in response to completion of the respective operation of the stored event having the latest time, to control the power supply to switch from the powered-up state to, according to said information, either the standby state or the shutdown state.

2. A television apparatus according to claim 1 wherein said television apparatus is arranged to store said information for each respective event and said controller is only responsive to said information stored for said stored event having the latest time.

3. A television apparatus according to claim 1 wherein:
said television apparatus further includes a mode register;
said information is stored in the mode register as either a standby mode or a shutdown mode; and
said controller is arranged so as, upon completion of the respective operation of the stored event having the latest time, to refer to the event register and to control the power supply to switch to the standby state when the standby mode is stored or to switch to the shutdown state when the shutdown mode is stored.

4. A television apparatus according to claim 1 wherein the controller is arranged so as, in response to completion of the respective operation of any event other than the event having the latest time, to control the power supply to switch from the powered-up state to the standby state.

5. A television apparatus according to claim 1 further including a clock for representing the current time.

6. A television apparatus according to claim 1 wherein the operations can include one or more of recording a received television programme, reproducing a television programme and uploading software/middleware upgrades.

7. A television apparatus according to claim 1 wherein the television apparatus is arranged to function as one or more of a television receiver, a television programme recording device and a television programme reproducing device.

8. A method of controlling a television apparatus, the television apparatus being either in a shutdown state or operable in a standby state or a powered-up state, the method including:
storing a plurality of events, each event indicating both a time and an operation to be conducted by the television apparatus at that time;
upon reaching a time stored for one of said events, switching from the standby state to the powered-up state and conducting the respective operation;
storing information indicating, for at least the stored event having the latest time, whether to switch to the standby state or the shutdown state; and
upon completing the respective operation of the stored event having the latest time, switching from the powered-up state to either the standby state or the shutdown state according to the stored information.

9. A computer program comprising program code means for performing, when said program is run on a computer or television apparatus, a method of controlling a television apparatus, the television apparatus being either in a shutdown state or operable in a standby state or a powered-up state, including:
storing a plurality of events, each event indicating both a time and an operation to be conducted by the television apparatus at that time;
upon reaching a time stored for one of said events, switching from the standby state to the powered-up state and conducting the respective operation;
storing information indicating, for at least the stored event having the latest time, whether to switch to the standby state or the shutdown state; and
upon completing the respective operation of the stored event having the latest time, switching from the powered-up state to either the standby state or the shutdown state according to the stored information.

10. A computer program product comprising program code means stored on a computer-readable medium for performing, when said program product is run on a computer or a television apparatus, a method of controlling a television apparatus, the television apparatus being either in a shutdown state or operable in a standby state or a powered-up state, including:
storing a plurality of events, each event indicating both a time and an operation to be conducted by the television apparatus at that time;
upon reaching a time stored for one of said events, switching from the standby state to the powered-up state and conducting the respective operation;
storing information indicating, for at least the stored event having the latest time, whether to switch to the standby state or the shutdown state; and
upon completing the respective operation of the stored event having the latest time, switching from the powered-up state to either the standby state or the shutdown state according to the stored information.
